(19) United States
(12) Patent Application Publication
(10) Pub. No.: US 2019/0331263 A1
(43) Pub. Date: Oct. 31, 2019

(54) COUPLING ARRANGEMENT FOR SCREW COUPLING

(71) Applicant: Alfred Kärcher SE & Co. KG, Winnenden (DE)

(72) Inventors: Christian Langer, Noerdlingen (DE); Ralph Seitter, Backnang (DE)

(21) Appl. No.: 16/506,572

(22) Filed: Jul. 9, 2019

Related U.S. Application Data
(63) Continuation of application No. PCT/EP2017/082361, filed on Dec. 12, 2017.

(30) Foreign Application Priority Data
Jan. 10, 2017 (DE) 10 2017 100 357.6

(51) Int. Cl. F16L 19/02

(52) U.S. Cl. CPC F16L 19/0218

(57) ABSTRACT

A coupling arrangement is provided for a screw coupling for liquid conduits of a high-pressure cleaning device. The coupling arrangement is connectable in a liquid-tight manner to a further coupling arrangement of the screw coupling, and includes a conduit piece having a channel for liquid under pressure, a multi-start thread for screwing the coupling arrangement to the further coupling arrangement, and a clamping device which is clampable to a clamping face of the further coupling arrangement. The clamping device includes a dimensionally stable clamping ring mount on which a clamping ring is held, wherein the clamping ring is deformable and adaptable to the shape of the clamping face by pressing onto the clamping face of the further clamping arrangement. In addition, a screw coupling with a coupling arrangement of that kind is provided.

This application is a continuation of international application number PCT/EP2017/082361 filed on 12 Dec. 2017 and claims the benefit of German application number 10 2017 100 357.6 filed on 10 Jan. 2017, which are incorporated herein by reference in their entirety and for all purposes.

### BACKGROUND OF THE INVENTION

The invention relates to a coupling arrangement for a screw coupling for liquid conduits of a high-pressure cleaning device, wherein the coupling arrangement is connectable in a liquid-tight manner to a further coupling arrangement of the screw coupling and comprises a conduit piece having a channel for a liquid under pressure, and wherein the coupling arrangement comprises a multi-start thread for screwing the coupling arrangement to the further coupling arrangement of the screw coupling, and wherein the coupling arrangement comprises a clamping device which is clampable to a clamping face of the further coupling arrangement.

The invention also relates to a screw coupling with a coupling arrangement of that kind.

Screw couplings are used in high-pressure cleaning devices in order to connect liquid conduits to each other in a liquid-tight manner. By means of a screw coupling of the kind being discussed here, for example a high-pressure hose may be connected to the pressure outlet of a high-pressure cleaning appliance. A liquid-tight connection between the pressure hose and a liquid dispensing device, for example a spray gun, may also be produced. A liquid-tight connection between a spray gun and a spray lance as well as between a spray lance and a spray nozzle may also be produced by means of a screw coupling of that kind.

Screw couplings for liquid conduits of a high-pressure cleaning device typically have two coupling arrangements which may be screwed together. A first coupling arrangement comprises a first conduit piece which is connectable to a second conduit piece of a second coupling arrangement using a sealing element, in particular using a sealing ring, to produce a liquid-tight connection.

One of the two conduit pieces may form a nipple, for example, and the other conduit piece may form, for example, a sleeve formed complementarily to the nipple, wherein the nipple is insertable into the sleeve and connectable to the sleeve in a liquid-tight manner by means of a sealing ring. The sealing ring may be arranged in an outer annular groove of the nipple or in an inner annular groove of the sleeve.

In order to ensure that the two coupling arrangements do not unintentionally release from each other, the coupling arrangements have mutually cooperating threads, such that they may be screwed together. The threads of the coupling arrangements are often configured to be single-start, and have a very small pitch angle. These threads are self-locking and ensure that the two coupling arrangements of the screw coupling do not release from each other even if the liquid conveyed by the high-pressure cleaning device has a very high pressure, for example a pressure of more than 100 bar, wherein momentary pressure peaks of 300 bar may occur. The single-start threads have the disadvantage, however, that they must be rotated relative to each other over a plurality of rotations in order to produce a mechanically stable screw connection. This makes the production of the screw connection time consuming and makes the handling of the screw coupling difficult.

A screw coupling with a coupling arrangement of the kind stated at the outset is known from the publication WO 2015/193164 A1. In this coupling arrangement, a multi-start thread is used, i.e. a threading in which a plurality of threads run parallel to each other helically about the thread longitudinal axis. The use of a multi-start thread has the advantage that the thread may have a high pitch, such that a significant axial movement can be achieved by one single rotation. A load being applied to the threading is simultaneously accommodated by a plurality of threads. For example, provision may be made for the multi-start thread to perform with one single rotation an axial movement of at least 5 mm, in particular an axial movement of 6 mm. This makes it easier to handle the coupling arrangement when producing a liquid-tight connection.

When using a multi-start thread, the user must, for example, rotate the thread only once by one full rotation relative to the thread of the further coupling arrangement, and already as a result of this one single rotation, a liquid-tight connection between the conduit piece of the one coupling arrangement and the associated conduit piece of the further coupling arrangement is produced.

Multi-start threads, however, are usually not self-locking, as the pitch angle is relatively large. It is therefore proposed in WO 2015/193164 A1 to not only screw the coupling arrangements together, but also to clamp them together. For this purpose, the coupling arrangements each have a clamping device with a clamping face and, when screwing the coupling arrangements together, the clamping faces are guided axially into each other, such that they clamp to each other. The clamping faces are configured as conical annular faces which are formed complementarily to each other.

The use of clamping faces formed complementarily to each other thus makes it possible to screw a first coupling arrangement to a second coupling arrangement in a simple manner by means of a multi-start thread, without the risk that the screw connection unintentionally releases. The manufacturing of the clamping faces is costly, however, because a high dimensional accuracy is required in order to ensure a clamping effect.

In accordance with an embodiment of the invention, provision is made to further develop a coupling arrangement of the kind stated at the outset in such a way that it may be produced more inexpensively.

### SUMMARY OF THE INVENTION

In accordance with an embodiment of the invention, a coupling arrangement of the generic type is provided in which the clamping device comprises a dimensionally stable clamping ring mount on which a clamping ring is held, wherein the clamping ring is deformable and adaptable to the shape of the clamping face by pressing onto the clamping face of the further clamping arrangement.

In the coupling arrangement in accordance with the invention, a clamping device is used with a deformable clamping ring which is held on a dimensionally stable clamping ring mount. When the coupling arrangement in accordance with the invention is screwed to a further coupling arrangement of the screw coupling, the clamping ring is pressed against the clamping face of the further coupling arrangement and is hereby deformed in such a way that the clamping ring adapts to the shape of the clamping face of the further coupling arrangement. The deformable clamping ring is held on the dimensionally stable clamping ring mount, such that it is pressed between the coupling arrangement and the further coupling arrangement when producing the screw connection. As a result, a clamping effect is achieved, which acts against an unintentional release of the screw connection.

The use of the deformable clamping ring makes it possible to reduce the requirements for the dimensional accuracy of the clamping device, such that the costs for the production of the coupling arrangement in accordance with the invention may be reduced.

In an advantageous embodiment of the coupling arrangement in accordance with the invention, said coupling arrangement is releasably connectable to the further coupling arrangement of the screw coupling. This has the advantage that the liquid-tight connection between the coupling arrangement and the further coupling arrangement of the screw coupling may be released and reproduced at a later point as required.

The thread of the coupling arrangement in accordance with the invention is of quadruple-thread configuration.

In an advantageous embodiment, the coupling arrangement comprises a connecting sleeve which is held on the conduit piece and on which the multi-start thread is arranged. With the aid of the multi-start thread, the connecting sleeve may be screwed to a complementarily formed multi-start thread of the further coupling arrangement.

The multi-start thread of the connecting sleeve is preferably configured as an internal thread of the connecting sleeve.

It is favorable if the connecting sleeve forms a screw collar ring which is held on the conduit piece so as to be freely rotatable. This facilitates the production of the screw connection between the coupling arrangement and the further coupling arrangement of the screw coupling.

In an advantageous embodiment of the invention, the clamping ring mount is configured as an annular groove in which the clamping ring is arranged. The annular groove may, for example, be configured as a circumferential groove which surrounds the conduit piece in circumferential direction and accommodates the deformable clamping ring.

In an advantageous embodiment of the invention, the clamping ring mount forms an annular groove which is formed on the inside of the connecting sleeve and in which the clamping ring is arranged. In an embodiment of that kind, the connecting sleeve preferably comprises a multi-start internal thread which cooperates with a complementarily formed external thread of the further coupling arrangement, and an inner annular groove in which the clamping ring is arranged. When screwing the coupling arrangement, the inner clamping ring may come into abutment against an outer clamping face of the further coupling arrangement and be pressed against the outer clamping face, wherein the clamping ring is deformed in such a way that it adapts to the shape of the outer clamping face, such that an areal contact between the clamping ring and the clamping face is achieved.

The clamping ring is preferably configured in such a way that, in the deformed state, it forms an areal contact with the clamping face, which contact extends continuously over the entire circumference of the clamping face.

In an advantageous embodiment of the invention, the annular groove is arranged on the inside of the connecting sleeve between the internal thread and a free end face of the connecting sleeve. In an embodiment of that kind, the annular groove is thus arranged in front of the internal thread on the inside of the connecting sleeve in relation to the screwing direction of the internal thread. As a result of the clamping abutment of the clamping ring against the associated clamping face of the further coupling arrangement, in an embodiment of that kind, not only is a clamping effect achieved, but the deformable clamping ring also ensures that dirt particles cannot easily get from the free end face of the connecting sleeve to the internal thread.

Provision may be made for the clamping ring in the deformed state to form a conical annular face. The annular face thus forms a truncated cone-shaped region of the clamping ring, with which the clamping ring abuts against a complementarily formed truncated cone-shaped clamping face of the further coupling arrangement.

In the undeformed state, i.e. before the production of a screw connection between the coupling arrangement and the further coupling arrangement, the clamping ring has in an advantageous embodiment of the invention a round or angular cross sectional area, in particular an oval, circular, rectangular, or trapezoidal cross sectional area.

An, in the undeformed state, rectangular cross sectional area of the clamping ring with two longitudinal sides aligned parallel to each other and with two narrow sides aligned parallel to each other and at a right angle to the longitudinal sides has proven to be particularly advantageous. When producing the screw connection between the coupling arrangement and the further coupling arrangement, one of the longitudinal or narrow sides may come into abutment against a conically formed clamping face of the further coupling arrangement and hereby adapt to the conical shape of the clamping face, such that the cross sectional area of the clamping ring transitions starting from a rectangular shape into a trapezoidal shape as a result of pressing onto the clamping face of the further coupling arrangement.

It is advantageous if the clamping ring is connected to the clamping ring mount in a positively-fitting manner. For example, provision may be made for the clamping ring mount to form a groove which is rectangular in cross section and which is completely filled by the clamping ring, wherein the clamping ring protrudes out of the groove and in its protruding region is adaptable to the shape of the clamping face of the further coupling arrangement when producing a screw connection between the coupling arrangement and the further coupling arrangement of the screw coupling.

It is favorable if the clamping ring is replaceably held in the clamping ring mount. This makes it possible to replace the clamping ring in a simple manner, for example in the case of damage, by removing it from the clamping ring mount and placing a new clamping ring into the clamping ring mount.

The clamping ring is preferably compressible. In an embodiment of that kind, the clamping ring may be pressed together between the coupling arrangement and the further coupling arrangement when producing the screw connection and thereby adapt its shape to the shape of the associated clamping face of the further coupling arrangement.

The clamping ring is favorably elastically deformable and in particular compressible.

In an advantageous embodiment of the invention, the clamping ring consists of plastic, in particular of a polyurethane material.

The clamping ring preferably has a shore hardness of at least 70 shore A, in particular a shore hardness in the range of 75 shore A to 95 shore A, for example 85 shore A. A hardness of that kind makes it possible to deform the clamping ring when producing the screw connection between the coupling arrangement and the further coupling arrangement in such a way that it adapts to the shape of the clamping face of the further coupling arrangement, wherein it is also ensured that the deformed clamping ring generates a sufficient clamping effect in order to prevent an unintentional release of the screw connection.

The invention also relates to a hose coupling for liquid conduits of a high-pressure cleaning device, said coupling having a first coupling arrangement of the kind described above and having a second coupling arrangement which is connectable in a liquid-tight manner to the first coupling arrangement, wherein the second coupling arrangement comprises a second conduit piece having a channel for liquid under pressure, and a second multi-start thread which cooperates with the multi-start first thread of the first coupling arrangement, and a dimensionally stable clamping face which cooperates with the deformable clamping ring of the first coupling arrangement. When the first coupling arrangement is screwed to the second coupling arrangement of the screw coupling, the clamping ring of the first coupling arrangement is thus pressed against the clamping face of the second coupling arrangement, said clamping ring being deformed and adapting to the shape of the clamping face. A clamping effect is thereby produced, which prevents an unintentional release of the screw connection between the two coupling arrangements.

In an advantageous embodiment of the screw coupling in accordance with the invention, one of the two conduit pieces of the screw coupling forms a nipple which, with the interposition of a sealing element, in particular a sealing ring, is insertable into a sleeve-shaped receiving region of the other conduit piece.

A connecting sleeve, in particular a screw collar ring, is preferably held on the conduit piece of the first coupling arrangement, said screw collar ring having a multi-start internal thread and an internal annular groove in which the clamping ring is arranged, and the conduit piece of the second coupling arrangement has an external thread and an external, in particular conically formed clamping face. The connecting sleeve may be screwed onto the second conduit piece, wherein the internal clamping ring of the first coupling arrangement comes into abutment against the external clamping face of the second coupling arrangement and is deformed such that a clamping effect is produced that prevents an unintentional release of the screw connection between the two coupling arrangements.

The subsequent description of a preferred embodiment of the invention serves in conjunction with the drawing for further explanation. In the drawings:

### BRIEF DESCRIPTION OF THE DRAWINGS

FIG. 1 shows a schematic longitudinal sectional view of a screw coupling with a first coupling arrangement and a second coupling arrangement, which are screwed and clamped together;

FIG. 2 shows an enlarged depiction of Detail A from FIG. 1, wherein a conduit piece with a nipple of the first coupling arrangement is hidden;

FIG. 3 shows an enlarged depiction corresponding to FIG. 2 before the screwing and clamping of the two coupling arrangements.

### DETAILED DESCRIPTION OF THE INVENTION

Schematically depicted in the drawing is an advantageous embodiment of a screw coupling in accordance with the invention, which is designated as a whole with the reference numeral 10. The screw coupling comprises a first coupling arrangement 12 in accordance with the invention and a second coupling arrangement 14 which are able to be screwed and clamped together in a liquid-tight manner and separated from each other again as required, without any special tools.

The first coupling arrangement 12 has a first conduit piece 16 with a through-channel 18. The first conduit piece 16 forms a nipple 20. In the embodiment depicted, a steel pipe 24, which is known per se and is therefore shown only in sections for achieving a better overview, is connected to the end 22 of the conduit piece 16 remote from the nipple 20. The nipple has at a small distance from its free end face 26 a first annular groove 28 in which a sealing ring 30 is arranged, and in a region between the nipple 20 and the steel pipe 24, the first conduit piece 26 has an external circumferential groove 32.

The first coupling arrangement 12 also has a connecting sleeve 34 which is configured as a screw collar ring 36 in the embodiment depicted. The screw collar ring 36 comprises a circumferential wall 38 which surrounds the nipple 20 while forming an annular space 40 and to which a rear wall 42 connects that is passed through by the first conduit piece 16 and that dips into the circumferential groove 32. The screw collar ring 36 is freely rotatably in the circumferential groove 32 and is mounted so as to be practically non-displaceable in axial direction.

At a small distance from the rear wall 42, a multi-start internal thread 46 is arranged on the inside 44 of the circumferential wall 38. In the embodiment depicted, the internal thread 46 is of quadruple-thread configuration.

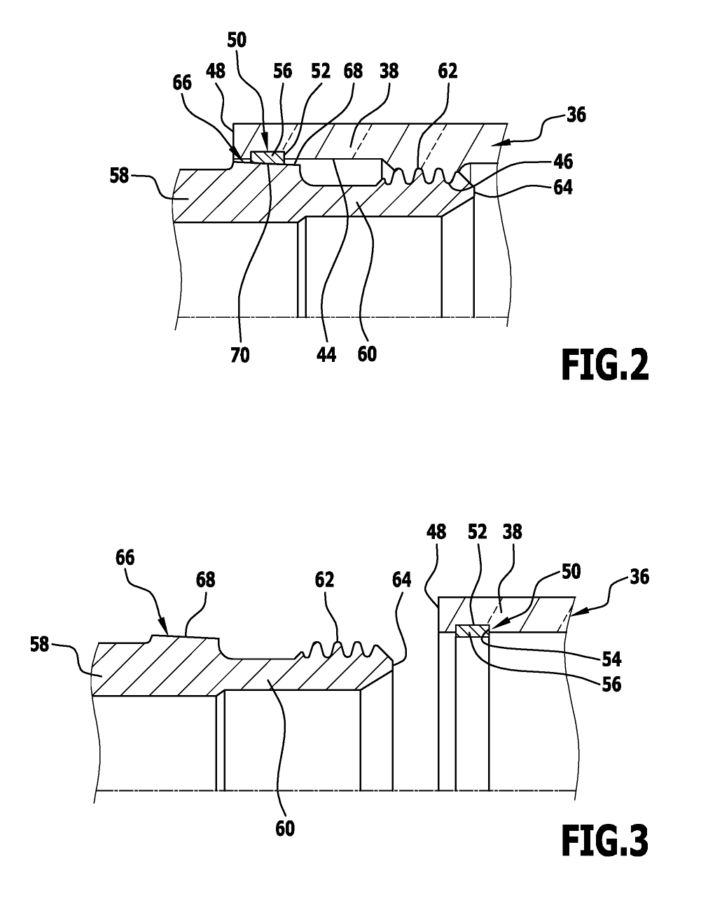

Remote from the rear wall 42, the screw collar ring 36 has a free end face 48. In the region between the internal thread 46 and the free end face 48, arranged on the inside 44 of the circumferential wall 38 is a clamping device 50 which is depicted enlarged in FIGS. 2 and 3. The clamping device 50 comprises a clamping ring mount 52, which is configured in the embodiment depicted as a second annular groove 54, and a clamping ring 56 which is held in the second annular groove 54.

The clamping ring 56 is elastically compressible and deformable. In the embodiment depicted, the clamping ring 56 consists of plastic, in particular of a polyurethane material. The clamping ring 56 has a hardness of 85 shore A in the embodiment depicted.

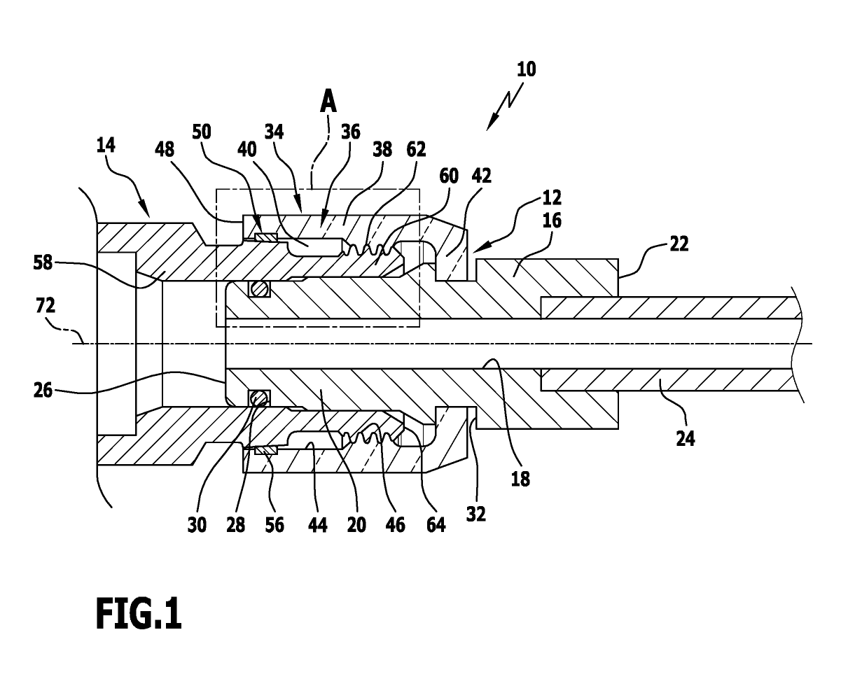

The second coupling arrangement 14 has a second conduit piece 58 with a through-channel and a sleeve-shaped receiving region 60 into which the nipple 20 of the first coupling arrangement 12 is able to be inserted with the interposition of the sealing ring 30, as is depicted in FIG. 1. On its outside, the second conduit piece 58 bears an external thread 62 of quadruple-thread configuration which is formed complementarily to the internal thread 46 of quadruple-thread configuration of the first coupling arrangement 12 and which is arranged at a small distance from the free end 64 of the sleeve-shaped receiving region 60. At a distance from the external thread 62, the second conduit piece 58 has on its outside an outer cone 66 which forms a conical clamping face 68. The outside diameter of the outer cone 66 enlarges continuously with increasing distance from the free end 64 of the receiving region 60.

When inserting the nipple 20 into the receiving region 60, the second conduit piece 58 dips into the annular space 40 between the nipple 20 and the screw collar ring 36, and the external thread 62 may be screwed to the internal thread 46. The elastically deformable and compressible clamping ring 56 comes into abutment against the conical clamping face 68 and is increasingly deformed, wherein it adapts to the shape of the clamping face 68 and is pressed between the second conduit piece 58 and the screw collar ring 36.

The clamping ring 56 has in its undeformed state depicted in FIG. 3 a rectangular cross-sectional area. By pressing onto the clamping face 68, the clamping ring 56 deforms in such a way that it has a trapezoidal shape in the deformed state depicted in FIG. 2, wherein it lies with a conical annular face 70 in areal contact against the clamping face 68. The conical annular face 70 is formed complementarily to the conical clamping face 68 and is aligned coaxially to the longitudinal axis 72 of the two conduit pieces 16 and 58, wherein the longitudinal axis 72 also forms a thread longitudinal axis of the internal thread 46 and the external thread 62.

As is clear in particular from FIGS. 2 and 3, the second annular groove 54 is configured to be rectangular in cross section and the clamping ring 56 is connected to the second annular groove 54 in a positively-fitting manner by it completely filling the second annular groove 54. In a region protruding out of the second annular groove 54, the clamping ring 56 forms the ring face 70 which is of conical configuration in the deformed state.

The clamping ring 56 is preferably replaceably held in the second annular groove 54, such that it may be replaced in a simple manner in the case of damage.

Because the internal thread 46 and the external thread 62 are of quadruple-thread configuration, a liquid-tight screw connection between the first coupling arrangement 12 and the second coupling arrangement 14 may be produced in a simple manner, and by using the clamping ring 56 and the clamping face 68, a clamping effect may be produced, which prevents an unintentional release of the screw connection. The requirements for the dimensional accuracy of the dimensionally stable clamping face 68 and the dimensionally stable clamping ring mount 52 may be kept relatively low. This enables an inexpensive production of the two coupling arrangements 12 and 14 and thus also of the hose coupling 10 as a whole.

1. A coupling arrangement for a screw coupling for liquid conduits of a high-pressure cleaning device,
wherein the coupling arrangement is connectable in a liquid-tight manner to a further coupling arrangement of the screw coupling and comprises a conduit piece having a channel for a liquid under pressure;
wherein the coupling arrangement comprises a multi-start thread for screwing the coupling arrangement to the further coupling arrangement of the screw coupling;
wherein the coupling arrangement comprises a clamping device which is clampable to a clamping face of the further coupling arrangement;
wherein the clamping device comprises a dimensionally stable clamping ring mount on which a clamping ring is held; and
wherein the clamping ring is deformable and is adaptable to the shape of the clamping face by pressing onto the clamping face of the further coupling arrangement.

2. The coupling arrangement in accordance with claim 1, wherein the coupling arrangement is releasably connectable to the further coupling arrangement of the screw coupling.

3. The coupling arrangement in accordance with claim 1, wherein the coupling arrangement comprises a connecting sleeve which is held on the conduit piece and on which the multi-start thread is arranged.

4. The coupling arrangement in accordance with claim 3, wherein the thread is configured as an internal thread of the connecting sleeve.

5. The coupling arrangement in accordance with claim 4, wherein the connecting sleeve forms a screw collar ring which is held on the conduit piece so as to be freely rotatable.

6. The coupling arrangement in accordance with claim 1, wherein the clamping ring mount forms an annular groove in which the clamping ring is arranged.

7. The coupling arrangement in accordance with claim 4, wherein the clamping ring mount forms an annular groove which is arranged on the inside of the connecting sleeve and in which the clamping ring is arranged.

8. The coupling arrangement in accordance with claim 7, wherein the annular groove is arranged between the internal thread and a free end face of the connecting sleeve.

9. The coupling arrangement in accordance with claim 1, wherein the clamping ring in the deformed state forms a conical annular face.

10. The coupling arrangement in accordance with claim 9, wherein the conical annular face is aligned coaxially to the thread longitudinal axis of the thread.

11. The coupling arrangement in accordance with claim 1, wherein the clamping ring in the undeformed state has a round or angular cross sectional area, in particular an oval, circular, rectangular, or trapezoidal cross-sectional area.

12. The coupling arrangement in accordance with claim 1, wherein the clamping ring is connected to the clamping ring mount in a positively-fitting manner.

13. The coupling arrangement in accordance with claim 1, wherein the clamping ring is replaceably held on the clamping ring mount.

14. The coupling arrangement in accordance with claim 1, wherein the clamping ring is elastically deformable.

15. The clamping arrangement in accordance with claim 1, wherein the clamping ring is compressible.

16. The coupling arrangement in accordance with claim 1, wherein the clamping ring consists of plastic, in particular of a polyurethane material.

17. The coupling arrangement in accordance with claim 1, wherein the clamping ring has a hardness of at least 70 shore A, in particular a hardness in the range of 75 shore A to 95 shore A, for example 85 shore A.

18. A hose coupling for liquid conduits of a high-pressure cleaning device, said coupling having a first coupling arrangement in accordance with claim 1 and having a second coupling arrangement which is connectable in a liquid-tight manner to the first coupling arrangement, wherein the second coupling arrangement comprises a second conduit piece having a channel for liquid under pressure, and a second multi-start thread which cooperates with the thread of the first coupling arrangement, and a dimensionally stable clamping face cooperating with the clamping ring of the first coupling arrangement.
